(19) United States
(12) Patent Application Publication
(10) Pub. No.: US 2025/0264161 A1
(43) Pub. Date: Aug. 21, 2025

(54) VALVE ASSEMBLY

(71) Applicant: SPM Oil & Gas Inc., Fort Worth, TX (US)

(72) Inventors: Andrew Hanson, Sherwood Park (CA); Ray Dicksang Pang, Missouri City, TX (US); David Kulikowski, Sherwood Park (CA); Brandon Travis Dodge, Troy, PA (US); Collin Garner, Fort Worth, TX (US)

(73) Assignee: SPM Oil & Gas Inc., Fort Worth, TX (US)

(21) Appl. No.: 18/581,582

(22) Filed: Feb. 20, 2024

(51) Int. Cl. F16K 3/02; E21B 34/02; F16K 3/20

(52) U.S. Cl. CPC F16K 3/0227; F16K 3/20; E21B 34/02

(57) ABSTRACT

A valve assembly includes a valve body defining an upstream end, a downstream end, and an opening extending along a central axis between the upstream end and the downstream end. The valve assembly also includes a valve gate movable relative to the valve body. The valve gate defines a first side proximal to the upstream end and a second side opposite to the first side proximal to the downstream end. The second side is opposite to the first side. The valve assembly further includes a valve seat disposed within the valve body adjacent to the valve gate. The valve assembly includes a sealing element disposed between the valve body and the valve seat and contacting each of the valve body and the valve seat. The sealing element urges the valve seat towards the valve gate.

### TECHNICAL FIELD

The present disclosure relates to a valve assembly.

### BACKGROUND

A valve, such as a gate valve, is used in drilling and mining applications to control a flow of fluid. For example, the valve may control fluid flow between a wellbore via a well head and a frac piping system including a pump. The valve defines an opening, an upper valve cavity, and a lower valve cavity. Each of the upper valve cavity and the lower valve cavity are in communication with the opening. The valve includes a valve gate and a pair of valve seats disposed adjacent to the valve gate. The valve gate is movable between an open position and a closed position. In the open position, the valve gate allows the fluid to flow through the opening towards a downstream end of the valve or vice versa. In the closed position, the valve gate prevents the flow of fluid towards the downstream end or vice versa.

Conventionally, during drilling and mining operations, debris, such as proppant or wellbore particulate, may enter the upper valve cavity and/or the lower valve cavity via a gap between the valve gate and a corresponding valve seat, or a gap between a valve body and a corresponding valve seat. Accumulation of the debris in the upper valve cavity or the lower valve cavity is not desirable and may reduce performance of the valve. Further, the debris accumulated in the upper valve cavity, or the lower valve cavity may damage one or more components of the valve, which may increase operational costs of the valve. Lastly, the upper and lower valve cavities are initially filled with lubricating grease which may be displaced by the fluid if the fluid enters the upper and lower valve cavities.

CN1517581A describes a sealing unit and method for sealing the joint part on a valve body. The first valve seat element is fixed in the valve casing. Two sealing rings are arranged between valve casing and plug-in part of casing and one sealing ring is arranged between said plug-in part and valve seat element for providing downstream sealing. An internal flange on one of valve seat elements and the slot on another valve seat element can prevent broken pieces from coming in gap between them.

### SUMMARY OF THE DISCLOSURE

In an aspect of the present disclosure, a valve assembly is provided. The valve assembly includes a valve body defining an upstream end, a downstream end, and an opening extending along a central axis between the upstream end and the downstream end. The valve assembly also includes a valve gate movable relative to the valve body. The valve gate defines a first side proximal to the upstream end and a second side proximal to the downstream end. The second side is opposite to the first side. The valve assembly further includes a valve seat disposed within the valve body adjacent to the valve gate. The valve assembly includes a sealing element disposed between the valve body and the valve seat and contacting each of the valve body and the valve seat. The sealing element urges the valve seat towards the valve gate.

In another aspect of the present disclosure, a valve assembly is provided. The valve assembly includes a valve body defining an upstream end, a downstream end, and an opening extending along a central axis between the upstream end and the downstream end. The valve body further defines a first notch extending circumferentially about the central axis. The first notch faces the opening in the valve body. The valve assembly also includes a valve gate movable relative to the valve body. The valve gate defines a first side proximal to the upstream end and a second side proximal to the downstream end. The second side is opposite to the first side. The valve assembly further includes a valve seat disposed within the valve body adjacent to the valve gate. The valve seat includes a flange extending about the central axis. The flange is received within the first notch in the valve body. The first notch and the flange together create a flow restriction to prevent fluid flow therethrough.

In yet another aspect of the present disclosure, a valve assembly is provided. The valve assembly includes a valve body defining an upstream end, a downstream end, and an opening extending along a central axis between the upstream end and the downstream end. The valve body further defines a first notch extending circumferentially about the central axis. The first notch faces the opening in the valve body. The valve assembly also includes a valve gate movable relative to the valve body. The valve gate defines a first side proximal to the upstream end and a second side proximal to the downstream end. The second side is opposite to the first side. The valve assembly further includes a valve seat disposed within the valve body adjacent to the valve gate. The valve seat includes a flange extending about the central axis. The flange is received within the first notch in the valve body. The first notch and the flange together create a flow restriction to prevent fluid flow therethrough. The valve assembly includes a sealing element disposed between the valve body and the valve seat and contacting each of the valve body and the valve seat. The sealing element urges the valve seat towards the valve gate.

In yet another aspect of the present disclosure, a valve assembly is provided. The valve assembly includes a valve body defining a first valve cavity proximal to an upper end of the valve body and a second valve cavity proximal to a lower end of the valve body. The valve assembly also includes a valve gate movable relative to the valve body. The valve assembly further includes a valve seat disposed within the valve body and adjacent to the valve gate. The valve assembly includes a retainer plate disposed within the second valve cavity of the valve body. The retainer plate is disposed adjacent to the valve gate. The retainer plate creates a flow restriction to prevent passage of fluid towards the second valve cavity.

Other features and aspects of this disclosure will be apparent from the following description and the accompanying drawings.

### BRIEF DESCRIPTION OF THE DRAWINGS

FIG. 1 is a schematic perspective view illustrating an exemplary frac tree connected to a wellhead;

FIG. 2 is a schematic cross-sectional view of a valve assembly of FIG. 1 illustrating a valve gate in an open position;

FIG. 3 is a schematic cross-sectional view of the valve assembly of FIG. 2 illustrating the valve gate in a closed position;

FIG. 4 is a cross-sectional view of a portion of the valve assembly of FIG. 2;

FIG. 5 is a schematic perspective view of an exemplary sealing element associated with the valve assembly of FIG. 2;

FIG. 6A is a schematic perspective view of a retainer plate associated with the valve assembly of FIG. 2; and

FIG. 6B is a schematic perspective view illustrating a pair of retainer plates and a pair of brackets associated with the valve assembly of FIG. 2.

### DETAILED DESCRIPTION

Wherever possible, the same reference numbers will be used throughout the drawings to refer to the same or like parts.

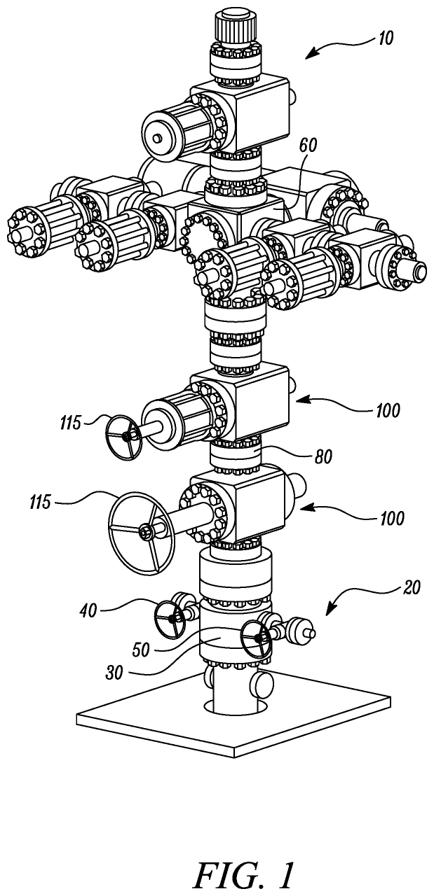

Referring to FIG. 1, a schematic perspective view of an exemplary frac tree 10 connected to a wellhead 20 is illustrated. The frac tree 10 is generally used in drilling and mining applications, such as, hydraulic fracturing. The frac tree 10 directs frac fluid between the wellhead 20 and a frac piping system including a pump (not shown). In some examples, the frac fluid may be water, oil, and the like, associated with drilling and mining applications. The frac fluid is hereinafter interchangeably referred to as “fluid”. The fluid may contain proppants, such as, sand, polymers, ceramics, and the like.

The frac tree 10 includes an adapter 30 which may also include opposing side valves 40, 50. In some examples, each of the side valves 40, 50 may be a wing gate valve. The frac tree 10 also includes a pair of valve assemblies 100. In the illustrative example of FIG. 1, each of the valve assembly 100 from the pair of valve assemblies 100 is connected in series with each other via a conduit 80, and therefore can be referred to as a lower valve assembly 100 disposed proximal to an upper end and an upper valve assembly 100 disposed proximal to a lower end. The adapter 30 connects the frac tree 10 with the wellhead 20. In some examples, the adapter 30 may also facilitate connection of the wellhead 20 to a casing string (not shown) and/or a tubing string (not shown) extending within the associated wellbore. Specifically, each valve assembly 100 may selectively control fluid flow between the wellhead 20 and the frac piping system including the pump. The frac tree 10 further includes a frac cross 60 coupled to the upper valve assembly 100. The frac cross 60 may allow connection between the frac tree 10 and alternate flow lines such as pump down lines and flowback lines.

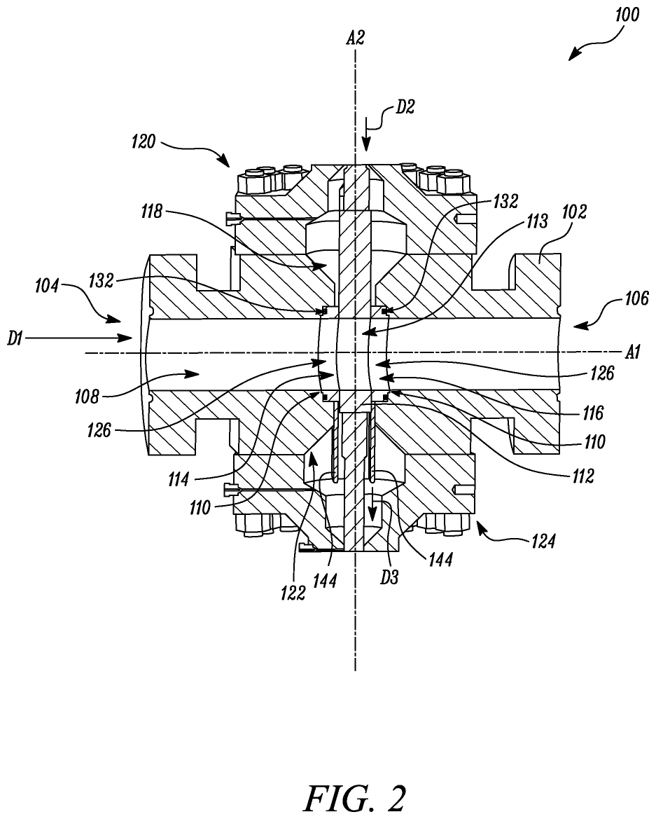

Referring to FIG. 2, a schematic cross-sectional view of the valve assembly 100 is illustrated. The valve assembly 100 includes a valve body 102. The valve body 102 defines an upstream end 104, a downstream end 106 opposite the upstream end 104, and an opening 108 extending along a central axis A1 between the upstream end 104 and the downstream end 106. The opening 108 allows fluid to flow from the upstream end 104 towards the downstream end 106 in a direction D1. Alternatively, the opening 108 may allow the fluid to flow from the downstream end 106 towards the upstream end 104 in a direction opposite to the direction D1.

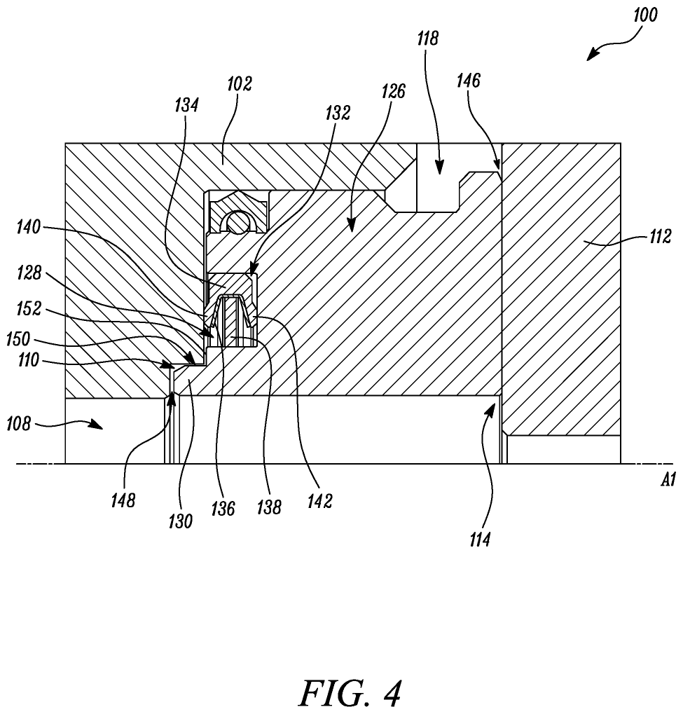

The valve body 102 further defines a first valve cavity 118 proximal to an upper end 120 of the valve body 102 and a second valve cavity 122 proximal to a lower end 124 of the valve body 102. The upper and lower ends 120, 124 are opposing ends of the valve body 102. The valve body 102 also defines a first notch 110 (best visible in FIG. 4) extending circumferentially about the central axis A1. The first notch 110 faces the opening 108 in the valve body 102. In the illustrated example of FIG. 2, the valve body 102 defines one first notch 110 proximal to the upstream end 104 and another first notch 110 proximal to the downstream end 106.

The valve assembly 100 also includes a valve gate 112 movable relative to the valve body 102. Specifically, the valve gate 112 moves between the first valve cavity 118 and the second valve cavity 122. The valve gate 112 defines an opening 113. The valve gate 112 is movable between an open position and a closed position. In the illustrated example of FIG. 2, the valve gate 112 is illustrated in the open position. In the open position of the valve gate 112, the opening 113 of the valve gate 112 is in alignment with the opening 108 such that the fluid can flow from the upstream end 104 towards the downstream end 106 or vice versa.

The valve assembly 100 further includes a gate actuator 115 (see FIG. 1) coupled to the valve gate 112 at the upper end 120 of the valve assembly 100. The gate actuator 115 may be used to move the valve gate 112 between the open position and the closed position. In other words, the gate actuator 115 may move the valve gate 112 along an axis A2 perpendicular to the central axis A1. In some examples, the gate actuator 115 may be a manual actuator that may be operated by a user via a hand wheel. Alternatively, the gate actuator 115 may be a hydraulic actuator, pneumatic actuator, an electrical actuator, and the like, to move the valve gate 112.

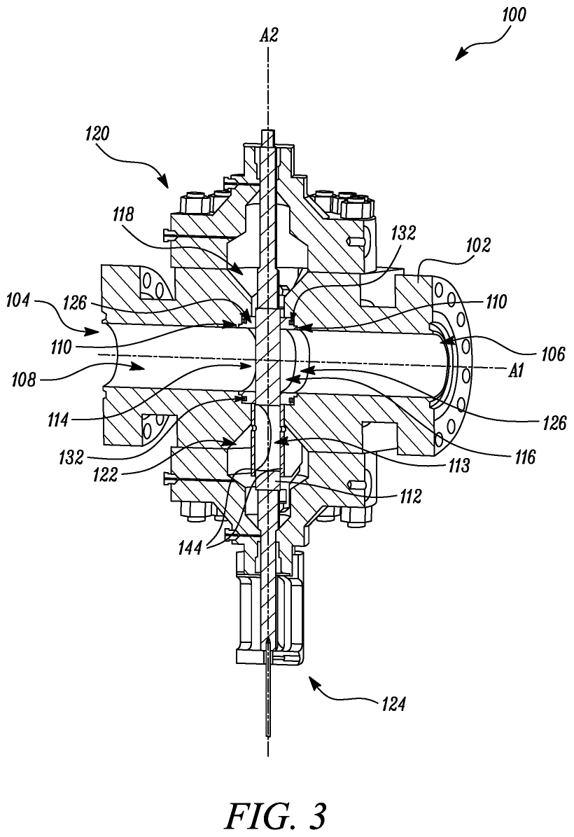

Referring to FIG. 3, a schematic cross-sectional view of the valve assembly 100 is illustrated. The valve gate 112 is shown in the closed position in FIG. 3. In the closed position of the valve gate 112, the opening 113 of the valve gate 112 is not in alignment with the opening 108 such that the valve gate 112 prevents or restricts the fluid to flow from the upstream end 104 towards the downstream end 106 or vice versa.

The valve gate 112 defines a first side 114 proximal to the upstream end 104 and a second side 116 proximal to the downstream end 106. The second side 116 is opposite to the first side 114.

The valve assembly 100 further includes a valve seat 126 disposed within the valve body 102 adjacent to the valve gate 112. Particularly, the valve seat 126 is a first valve seat 126 disposed at the first side 114 of the valve gate 112. The valve assembly 100 further includes a second valve seat 126 disposed at the second side 116 of the valve gate 112. The first valve seat 126 and the second valve seat 126 are hereinafter interchangeably referred to as “valve seat 126”.

Referring to FIG. 4, a cross-sectional view of a portion of the valve assembly 100 of FIGS. 1 to 3 is illustrated. It should be noted that only the valve seat 126 disposed at the first side 114 of the valve gate 112 is illustrated in FIG. 3, however, details provided herein are equally applicable to the valve seat 126 disposed at the second side 116 (see FIGS. 2 and 3) of the valve gate 112. The valve seat 126 defines a second notch 128 extending circumferentially about the central axis A1. The valve seat 126 includes a flange 130 extending about the central axis A1. The flange 130 is received within the first notch 110 in the valve body 102. The first notch 110 and the flange 130 together create a flow restriction to prevent fluid flow therethrough. In other words, the flange 130 and the first notch 110 together create a tortuous path for fluid to severely restrict the fluid from flowing towards the first valve cavity 118 and correspondingly to the second valve cavity 122.

Fluid along with proppant may flow into gaps 148 and 150 formed between the valve body 102 and the valve seat 126 towards a face 152 of the valve seat 126, and thereby towards the first valve cavity 118 and the second valve cavity 122 (see FIG. 3). In order to prevent accumulation of proppant at the face 152 of the valve seat 126 and inside the first and second valve cavities 118, 122, the flange 130 and the first notch 110 together create the tortuous path for fluid to prevent accumulation of the proppant.

The valve assembly 100 includes a sealing element 132 disposed between the valve body 102 and the valve seat 126 and contacting each of the valve body 102 and the valve seat 126. Particularly, the sealing element 132 is disposed within the second notch 128 of the valve seat 126. The sealing element 132 urges the valve seat 126 towards the valve gate 112. Particularly, the sealing element 132 is a first sealing element 132 disposed between the first valve seat 126 and the valve body 102. The valve assembly 100 further includes a second sealing element 132 (see FIGS. 2 and 3) disposed between the second valve seat 126 (see FIGS. 2 and 3) and the valve body 102.

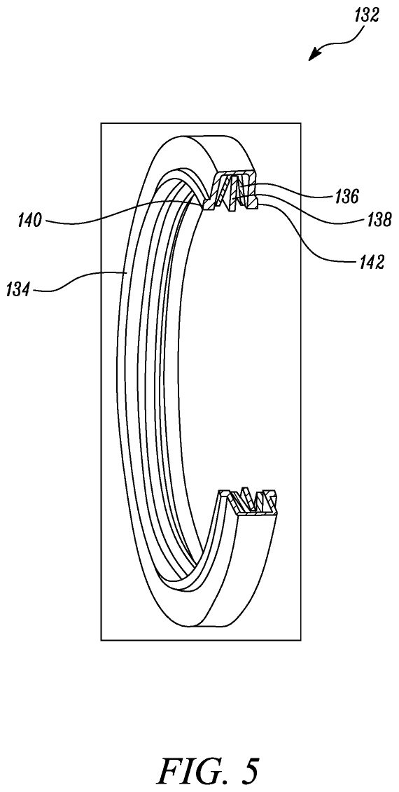

Referring to FIG. 5, a schematic perspective view of the sealing element 132 is illustrated. With reference to FIGS. 4 and 5, the sealing element 132 includes an annular seal 134. The annular seal 134 engages with each of the valve seat 126 and the valve body 102. The annular seal 134 has a U-shaped cross section such that one portion 140 of the annular seal 134 engages with the valve body 102 and another portion 142 of the annular seal 134 engages with the valve seat 126. Alternatively, the annular seal 134 may have a V-shaped cross section, a circular cross section, or any cross-section as desired. In some examples, the annular seal 134 may be made of a polymer. In other examples, the annular seal 134 may be made of a metallic material, an alloy, or any other material, without any limitations.

The sealing element 132 also includes a spring element 136 received within the annular seal 134. The spring element 136 exerts a spring force on the valve seat 126 to engage the valve seat 126 with the valve gate 112. In other words, the spring element 136 exerts the spring force on the annular seal 134 that in turn exerts a force on the valve seat 126 to reduce/eliminate a gap 146 between the valve seat 126 and the valve gate 112, which may prevent fluid flow towards the first valve cavity 118. In some examples, the spring element 136 may be made of a metallic material. In an example, the spring element 136 may be made of an alloy spring. In other examples, the spring element 136 may be made of a polymer or any other material, without any limitations. In some embodiments, the annular seal 134 and the spring element 136 may consist of one integral unit.

The sealing element 132 further includes an annular shim 138 received within the spring element 136. The annular shim 138 may prevent inside surfaces of the annular seal 134 from collapsing if pressure is applied to the annular seal 134. In some examples, the annular shim 138 may be made of a metallic material, an alloy, a polymer, or any other material, without any limitations. In some embodiments, the annular shim 138 may be integral to the spring element 136. In some embodiments, the annular shim 138 may also be integral to the annular seal 134. It should be noted that a design of the sealing element 132 as described and illustrated in the present disclosure is exemplary in nature, and the sealing element 132 may include any other design and combination of components to serve the intended purpose.

Referring to FIGS. 2, 3, and 6A, the valve assembly 100 includes a retainer plate 144 disposed within the second valve cavity 122 of the valve body 102. Particularly, the retainer plate 144 is disposed adjacent to the valve gate 112. The retainer plate 144 extends at least partially across the second valve cavity 122 in a direction D3 (shown in FIG. 2) parallel to a direction of movement D2 (shown in FIG. 2) of the valve gate 112. The retainer plate 144 is a first retainer plate 144 disposed adjacent to the valve gate 112 at the first side 114 of the valve gate 112. The valve assembly 100 further includes a second retainer plate 144 disposed adjacent to the valve gate 112 at the second side 116 of the valve gate 112. The first retainer plate 144 and the second retainer plate 144 are hereinafter interchangeably referred to as “retainer plate 144”.

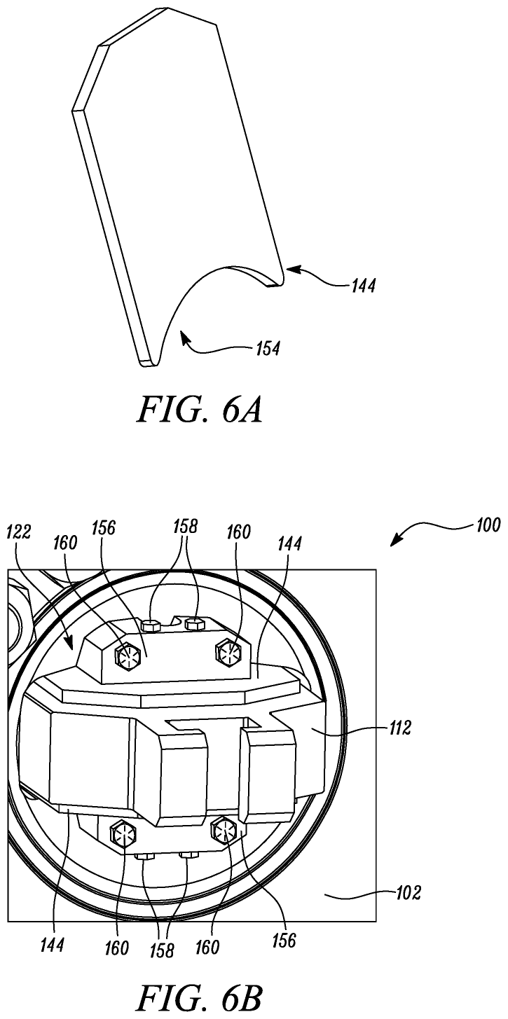

The retainer plate 144 may be removably disposed within the second valve cavity 122 with or without the use of any fastening means. For example, the retainer plate 144 may be simply placed within the second valve cavity 122 and held in place by adjacent components of the valve assembly 100. In an example, the retainer plate 144 may be fixedly coupled to the valve body 102, for example, via welding, brazing, soldering, and the like. In another example, the retainer plate 144 may be integral with the valve body 102. For example, the retainer plate 144 and the valve body 102 may be formed as a single integral component by casting, forging, machining, and the like. In yet another example, the retainer plate 144 may be removably coupled with the valve body 102 via a bracket 156 (shown in FIG. 6B) and one or more mechanical fasteners 158, 160 (shown in FIG. 6B).

The retainer plate 144 defines a cut-out 154 (shown in FIG. 6A) that receives at least a portion of the valve seat 126 therein. Specifically, the cut-out 154 in the first retainer plate 144 receives at least a portion of the first valve seat 126 and the cut-out 154 in the second retainer plate 144 receives at least a portion of the second valve seat 126 therein. The retainer plate 144 creates a flow restriction to prevent passage of fluid towards the second valve cavity 122. Specifically, each of the first retainer plate 144 and the second retainer plate 144 may create a tortuous path for the fluid which may severely restrict the fluid from entering the second valve cavity 122.

As shown in FIG. 6B, the valve assembly 100 may also include the bracket 156 disposed within the second valve cavity 122 to couple the retainer plate 144 with the valve body 102. The bracket 156 includes a first bracket 156 to couple the first retainer plate 144 with the valve body 102 and a second bracket 156 to couple the second retainer plate 144 with the valve body 102. It should be noted that a design of the bracket 156 as described herein is exemplary in nature, and the bracket 156 may be replaced by any other component that may facilitate coupling of the retainer plate 144 with the valve body 102.

The valve assembly 100 also includes the one or more mechanical fasteners 158 to couple the retainer plate 144 with the bracket 156. The valve assembly 100 further includes the one or more mechanical fasteners 160 to couple the bracket 156 with the valve body 102. The mechanical fasteners 158, 160 may include a bolt, a screw, a rivet, or the like.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure describes the valve assembly 100. The valve assembly 100 includes the valve seat 126 disposed adjacent to the valve gate 112. The valve seat 126 includes the flange 130 that engages with the first notch 110 defined by the valve body 102. The flange 130 and the first notch 110 create a stepped profile, thereby forming the tortuous path for the fluid which may prevent/restrict the fluid to flow towards the first valve cavity 118, via the gap 148. The flange 130 and the first notch 110 may also trap proppant for example, debris, therein and prevent or severely restrict passage of the proppant towards the sealing element 132.

The valve assembly also includes the sealing element 132 disposed within the second notch 128 of the valve seat 126. The sealing element 132 includes the annular seal 134 and the spring element 136. The spring element 136 exerts the spring force on the annular seal 134 that in turn exerts the force on the valve seat 126 to reduce/eliminate the gap 146 between the valve seat 126 and the valve gate 112. Thus, the sealing element 132 may prevent the fluid to enter the first valve cavity 118 via the gap 146 between the valve seat 126 and the valve gate 112. In other words, the sealing element 132 may seal the gap 146 between the valve seat 126 and the valve gate 112, thereby preventing accumulation of proppant, such as, sand, debris, and the like inside the first valve cavity 118.

The valve assembly 100 further includes the retainer plate 144 disposed within the second valve cavity 122. The valve assembly 100 may include the bracket 156 that couples with the valve body 102 and the retainer plate 144. When the valve gate 112 is in the closed position, the retainer plate 144 creates the tortuous path for the fluid, which may prevent entry of fluid towards the second valve cavity 122, thereby preventing accumulation of proppant inside the second valve cavity 122.

The valve assembly 100 of the present disclosure may demonstrate improved performance compared to the conventional valve assemblies. Furthermore, the valve assembly 100 may be cost-effective as the field servicing and maintenance costs associated with the valve assembly 100 may be reduced. Moreover, the valve assembly 100 described herein may have universal applicability, may be retrofitted on existing applications, and may improve efficiency of applications.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A valve assembly comprising:
a valve body defining an upstream end, a downstream end, and an opening extending along a central axis between the upstream end and the downstream end;
a valve gate movable relative to the valve body, the valve gate defining a first side proximal to the upstream end and a second side proximal to the downstream end, the second side being opposite to the first side;
a valve seat disposed within the valve body adjacent to the valve gate; and
a sealing element disposed between the valve body and the valve seat and contacting each of the valve body and the valve seat, wherein the sealing element urges the valve seat towards the valve gate.

2. The valve assembly of claim 1, wherein the valve seat includes a flange extending about the central axis, wherein the flange is received within a first notch in the valve body, and wherein the first notch and the flange together create a flow restriction to prevent fluid flow therethrough.

3. The valve assembly of claim 1, wherein the sealing element includes an annular seal engaging with each of the valve seat and the valve body.

4. The valve assembly of claim 3, wherein the sealing element further includes a spring element received within the annular seal, and wherein the spring element exerts a spring force on the valve seat to engage the valve seat with the valve gate.

5. The valve assembly of claim 4, wherein the spring element is made of a metallic material.

6. The valve assembly of claim 4, wherein the sealing element further includes an annular shim received within the spring element.

7. The valve assembly of claim 1, wherein the valve seat defines a second notch extending circumferentially about the central axis, and wherein the sealing element is received within the second notch of the valve seat.

8. The valve assembly of claim 1, wherein the valve seat is a first valve seat disposed at the first side of the valve gate and the sealing element is a first sealing element disposed between the first valve seat and the valve body, the valve assembly further comprising a second valve seat disposed at the second side of the valve gate and a second sealing element disposed between the second valve seat and the valve body.

9. A valve assembly comprising:
a valve body defining an upstream end, a downstream end, and an opening extending along a central axis between the upstream end and the downstream end, wherein the valve body further defines a first notch extending circumferentially about the central axis, and wherein the first notch faces the opening in the valve body;
a valve gate movable relative to the valve body, the valve gate defining a first side proximal to the upstream end and a second side proximal to the downstream end, the second side being opposite to the first side; and
a valve seat disposed within the valve body adjacent to the valve gate, wherein the valve seat includes a flange extending about the central axis, wherein the flange is received within the first notch in the valve body, and wherein the first notch and the flange together create a flow restriction to prevent fluid flow therethrough.

10. The valve assembly of claim 9, wherein the valve seat defines a second notch extending circumferentially about the central axis.

11. The valve assembly of claim 10 further comprising a sealing element received within the second notch of the valve seat, wherein the sealing element urges the valve seat towards the valve gate.

12. The valve assembly of claim 11, wherein the sealing element includes an annular seal engaging with each of the valve seat and the valve body.

13. The valve assembly of claim 12, wherein the sealing element further includes a spring element received within the annular seal, and wherein the spring element exerts a spring force on the valve seat to engage the valve seat with the valve gate.

14. The valve assembly of claim 13, wherein the sealing element further includes an annular shim received within the spring element.

15. The valve assembly of claim 11, wherein the valve seat is a first valve seat disposed at the first side of the valve gate and the sealing element is a first sealing element disposed between the first valve seat and the valve body, the valve assembly further comprising a second valve seat disposed at the second side of the valve gate and a second sealing element disposed between the second valve seat and the valve body.

16. A valve assembly comprising:
a valve body defining a first valve cavity proximal to an upper end of the valve body and a second valve cavity proximal to a lower end of the valve body;
a valve gate movable relative to the valve body;
a valve seat disposed within the valve body and adjacent to the valve gate; and
a retainer plate disposed within the second valve cavity of the valve body, wherein the retainer plate is disposed adjacent to the valve gate, and wherein the retainer plate creates a flow restriction to prevent passage of fluid towards the second valve cavity.

17. The valve assembly of claim 16, wherein the retainer plate defines a cut-out that receives at least a portion of the valve seat therein.

18. The valve assembly of claim 16, wherein the retainer plate is a first retainer plate disposed adjacent to the valve gate at a first side of the valve gate, the valve assembly further comprising a second retainer plate disposed adjacent to the valve gate at a second side of the valve gate, the second side being opposite to the first side.

19. The valve assembly of claim 16, wherein the retainer plate is at least one of fixedly coupled with the valve body, integral with the valve body, or removably coupled with the valve body via a bracket and one or more mechanical fasteners.

20. The valve assembly of claim 16, wherein the retainer plate extends at least partially across the second valve cavity in a direction parallel to a direction of movement of the valve gate.
